(19) United States
(12) Patent Application Publication
(10) Pub. No.: US 2010/0218249 A1
(43) Pub. Date: Aug. 26, 2010

(54) AUTHENTICATION VIA A DEVICE

(75) Inventors: Andrew D. Wilson, Seattle, WA (US); Stephen E. Hodges, Cambridge (GB); Peter B. Thompson, Redmond, WA (US); Meredith June Morris, Bellevue, WA (US); Paul Armistead Hoover, Kirkland, WA (US); William J. Westerinen, Sammamish, WA (US); Steven N. Bathiche, Kirkland, WA (US); Ian M. Sands, Seattle, WA (US); Shahram Izadi, Cambridge (GB); David Alexander Butler, Great Cambourne (GB); Matthew B. MacLaurin, Woodinville, WA (US); Arthur T. Whitten, Redmond, WA (US); William Ben Kunz, Seattle, WA (US); Shawn R. LeProwse, Mercer Island, WA (US); Hrvoje Benko, Seattle, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/392,405

(22) Filed: Feb. 25, 2009

(51) Int. Cl. H04L 9/32

(52) U.S. Cl. 726/19

(57) ABSTRACT

The claimed subject matter provides a system and/or a method that facilitates authentication of a user in a surface computing environment. A device or authentication object can be carried by a user and employed to retain authentication information. An authentication component can obtain the authentication information from the device and analyze the information to verify an identity of the user. A touch input component can ascertain if a touch input is authentication by associating touch input with the user. In addition, authentication information can be employed to establish a secure communications channel for transfer of user data.

### BACKGROUND

Computing devices are utilized by virtually everyone and in many different types of contexts (e.g., personal, social, professional, and so on). For example, it is common to see people communicating (e.g., telephone calls, text messages, emails, data transfer, and so forth) no matter where that person might be located (e.g., in a supermarket, in a library, taking public transportation, and so forth). As technology advances, so does the speed of communications and the demand for increased computing power. Further, data can be transferred across the country or across the globe in a matter of seconds. Based on the increased demands for computing capabilities, people are requiring more and more resources to be available for communicating electronically, whether the communication is with friends, family, coworkers, or others.

Computing technology has evolved such that touch screens and other devices (e.g., cameras) can track a user's gestural movements and make intelligent decisions regarding those movements. It has also become more commonplace for users to share a single computing environment and work together and/or separately within that computing environment. Since the demand for electronic computing devices is at an all time high, it is important to provide users with anytime, anywhere computing capabilities.

However, concerns can arise relative to security in a shared computing environment, especially when others within the computing environment can provide input possibly confused with another user. Such concerns can relate to protecting users from unauthorized inputs being received by the environment and any data security that can be associated.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

In accordance with one or more examples and corresponding disclosure thereof, various aspects are described in connection with authenticating a user with a surface computing environment via an authentication object. The authentication object can be an electronic device, mobile device, jewelry, pendant, etc., that is uniquely associated with the user. The authentication object enables the user to provide authenticated input to the surface computing environment to prevent unauthorized access to user data and/or unauthorized input originating from another user.

According to some aspects, a surface computing environment can obtain authentication information from an authentication object. The authentication information can be analyzed to determine an identity of a user associated with the authentication object. The user can interact with the surface computing environment via touch points. Touch points can be correlated with the authentication object and/or authentication information to enable the user to provide authenticated input.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates authenticating a user via a device, according to an aspect.

FIG. 2 illustrates a block diagram of an exemplary system that facilitates authenticating input and associating input with a user.

FIG. 3 illustrates a block diagram of an exemplary system that facilitates conveyance of authentication input to a surface computing environment in accordance with one or more aspects.

FIG. 4 illustrates a block diagram of an exemplary system that facilitates authenticating a user with a surface computing environment according to an aspect of the subject disclosure.

FIG. 5 illustrates a block diagram of exemplary system that provides authentication via devices.

FIG. 6 illustrates an exemplary methodology that facilitates obtaining authentication information from an authentication object.

FIG. 7 illustrates an exemplary methodology that facilitates employing authentication objects to enable authenticated input in a surface computing environment.

FIG. 8 illustrates an exemplary networking environment, wherein the novel aspects of the claimed subject matter can be employed.

FIG. 9 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “analyzer,” “authenticator,” “store,” “engine,” “modulator,” and the like are intended to refer to a computer-related entity, either hardware, software (e.g., in execution), and/or firmware. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

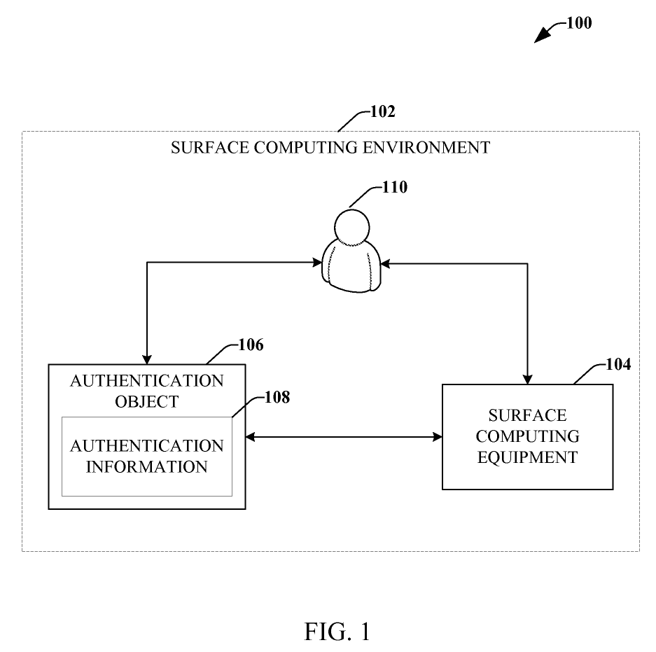

Now turning to the figures, FIG. 1 illustrates an example system 100 that facilitates authenticating a user via a device, according to an aspect. The disclosed aspects are configured to dynamically enable authentication of a user with a surface computing environment via an authentication object such as a device. The authentication object can retain authentication information that can be employed to enable identification of a user of the surface computing environment.

System 100 includes a surface computing environment 102 that includes surface computing equipment 104 that can be provided in various formats such as, but not limited to, a table, a wall, or any other suitable surface that can be configured to provide a computing experience and/or that can be utilized as a display. The surface computing equipment 104 can further allow interaction with and among a multitude of users. For example, the surface computing equipment 104 can be include in an environment 102 where a multitude of users interact, such as a meeting room, a coffee shop, and so forth. As the trend moves to using any surface (e.g., table, wall, and so forth) as a display, there can be multiple individuals interacting with the display at substantially the same time. Further, the surface computing environment 102 can allow users to share a single computing environment and work together and/or separately within that computing environment (e.g., classroom setting, business setting, conference, symposium, seminar, personal or family setting, and so forth). In addition, the surface computing environment 102 can be utilized to access and interact with user data. However, with multiple potential users interacting with the environment 102 simultaneously, users can be authenticated to allow interaction with user data. Further, user input can also be authenticated to prevent a user from accessing or interacting with data of other users.

System 100 includes an authentication object 106 that retains authentication information 108. The authentication object 106 can be a device such as an electronic device, a mobile device (e.g., cell phone, smart phone, PDA, etc.), a computing device and the like. In addition, the authentication object 106 can be a wearable object such as jewelry (e.g., ring, bracelet, etc.), a pendant, a key fob, a token or any other suitable object carried by a user and capable of retaining authentication information 108. According to an aspect, the authentication information 108 can be information that identifies a user 110. For example, the authentication can be a user ID for the surface computing equipment 104, a user ID associated with an online service (e.g., an online persona), a personal identification number, a password, a unique numeric identifier, a cryptographic key or the like.

The surface computing equipment 104 can obtain the authentication information 108 from the authentication object 106. For instance, the authentication object 106 can convey the information 108 to the equipment 104 via a variety of communication mediums as described infra. The surface computing environment 104 can analyze the authentication information 108 and identify user 110. Identification of user 110 can include associating the authentication information 108 with a particular user within the surface computing environment 102 and interacting with the surface computing environment 104. In addition, the authentication information 108 can be employed to obtain a user profile corresponding to user 110.

After identification of the user 110 via the authentication information 108, the surface computing equipment 104 can be employed to access and/or interact with data of user 110. For instance, the authentication information 108 can be employed to establish a secure communication channel between the authentication object 106 and the surface computing equipment 104. According to an aspect, user data can be obtained from the authentication object 106, another user object, a network (e.g., the cloud, a LAN, etc.) and so forth. Further, identification of the user 110 can be employed to associate user identify with touch input obtained by the surface computing equipment 104. For instance, certain user interactions with the surface computing equipment 104 can require validation of a user's identity such as, but not limited to, interactions to purchase products or services, to authorize future communications, or to provide personal data. The authentication object 106 and authentication information 108 can be employed by the surface computing equipment 104 to associate touch input with user 110 when required. Pursuant to an illustration, a location of the authentication object 106 relative to the surface computing equipment 104 and a location of the touch point on the surface computing equipment 104 can be evaluated to determine if an input is authenticated via the authentication object 106.

According to another aspect, the surface computing equipment 104 can provide visual feedback in the user interface to indicate that a particular touch input (e.g., a touch point) is authenticated. For example, the surface computing equipment 104 can utilize color visual feedback upon detecting a touch point. The color feedback can be colored light emitted at and around a location of a touch point. Visual feedback can be displayed in association with authenticated touch points. Moreover, each authenticated user can be assigned a particular color such that visual feedback of the particular color is displayed at touch points from an associated authenticated user. Upon verification of authentication information 108 from authentication object 106 of user 110, the surface computing equipment 104 can inform user 110 of an assigned color. Touch points originated from user 110 can be connected with visual feedback of the assigned color.

The surface computing equipment 104 and the authentication object 106 can employ a variety of mechanisms to exchange authentication information 108. For example, a radio frequency (RF) signal can be emitted through a user's body onto the surface computing equipment 104. The RF signal can include modulated authentication information 108. In such instance, the surface computing equipment 104 can include a capacitive array that detects the RF signal and employs filters to extract the authentication information 108. Whenever user 110 provides touch input to the surface computing equipment 104, the authentication information 108 is conveyed as well.

Pursuant to another illustration, the authentication information 108 can be conveyed via optical and/or physical mechanisms. For example, the authentication object 106 can include a display configured to transmit authentication information 108 by modulation of a backlight or through specific display patterns. In addition, the authentication object 106 can include a vibrator that can be configured to convey modulated authentication information 108 via a vibration pattern. Further, the authentication object 106 can be a mobile device or other electronic device capable of communication via short message service (SMS), near field communication (e.g., magnetic field induction), Bluetooth or other protocol that enables pairing, communication and data transfers.

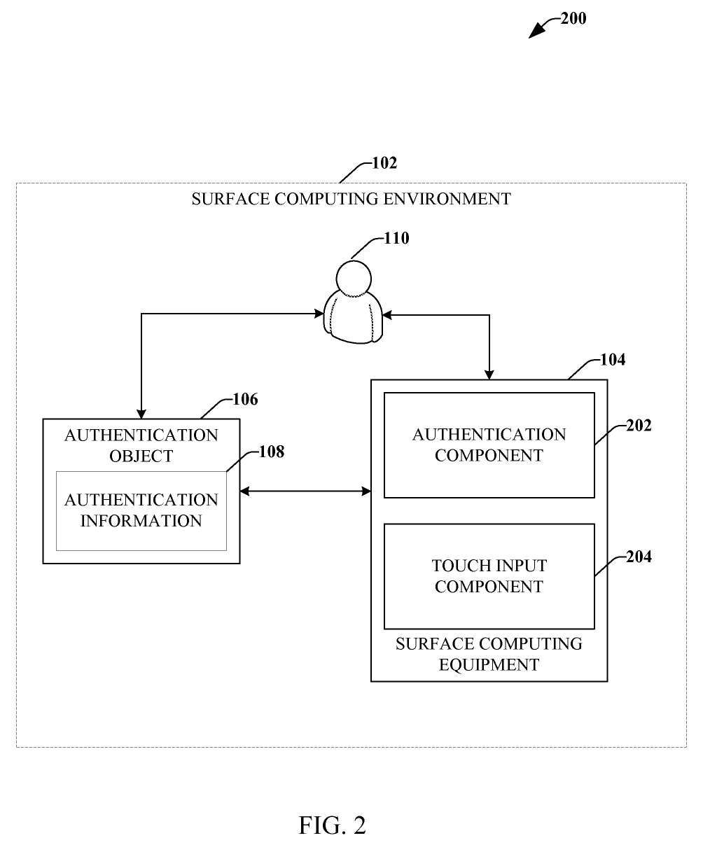

The surface computing equipment 104 can associate authentication information 108 with touch input (e.g., associate input with user 110). The surface computing equipment 104 can be provided authentication information 108 simultaneously with touch input, for example, with modulated capacitance and/or near field communication. Pursuant to another example, the surface computing environment 104 can employ optical mechanisms. For instance, the authentication object 106 can be placed on a surface display. A halo or authenticated region can be established on the surface display around the object 106 such that any touch input obtained within the region is associated with user 110 and authenticated according to information 108 associated with user 110. FIG. 2 illustrates a system 200 that facilitates authenticating input and associating input with a user within a surface computing environment. The user can interact with user data via within the surface computing environment after authentication. Further, authenticated input (e.g., input received from an authenticated user) can be obtained during interaction with user data and accepted while unauthenticated input is ignored.

System 200 can be included in a surface computing environment 102 that can be located in a variety of places (e.g., store, office, coffee shop, library, and so forth). It should be understood that although only a single (piece of) surface computing equipment 104 is illustrated (for purposes of simplicity), surface computing equipment 104 can comprise a multitude of pieces or sets of equipment (e.g., dual monitors). Further, the equipment 104 can be of different types (e.g., a surface on a table and a surface on a wall).

System 200 can also include an authentication object 106 that retains authentication information 108 uniquely associated with a user 110. The authentication object 106 can be an electronic device such as a mobile device (e.g., cell phone, smart phone, etc.), a PDA, computer, laptop and the like. In addition, the authentication object 106 can be a wearable object such as a watch, ring, bracelet, pendant, necklace, earrings, and so forth. It is to be appreciated that the authentication object 106 can be any suitable object generally carried by user 110 and capable of retaining authentication information 108 and transmitting the information 108 to the surface computing equipment 104.

A user 110 can walk into a room (or other area) and begin interacting with the surface computing equipment 104. In accordance with some aspects, the authentication object 106 can be located in a user's pocket, purse, or worn on the user's person. The surface computing equipment 104 can obtain the authentication information 108 corresponding to user 110 from the authentication object 106 in user's 110 possession. The surface computing equipment 104 includes an authentication component 202 that analyzes the obtained authentication information 108. The authentication component 202 can determine an identity of the user 110. For instance, the identity can be a relative identity that distinguishes user 110 from other users interacting with the surface computing equipment 104. The identity can be a user ID for the surface computing equipment 104, a user ID for an online service and the like. In addition, the authentication component 202 can establish a secure communication channel between the authentication object 106 and the surface computing equipment 104. Pursuant to an illustration, the authentication component 202 and the authentication object 106 can utilize cryptographic keys to establish secure communications. It is to be appreciated that other security techniques can be employed such as, but not limited to, passwords, pass codes, PINs, keys, biometrics, visual verifications and so forth.

After establishment of a secure channel and/or identification of user 110, user data can be accessed via the surface computing equipment 104. For instance, user data can be verified and unlocked to the surface computing equipment 104 from the authentication object 106 over the established secure channel. In addition, identity of user 110 can be employed to retrieve, unlock and access user data retained by the surface computing equipment 104 or stored in a cloud (not shown).

People can interact with the surface computing equipment 104 in a “hands-on” manner and, at substantially the same time. System 200 enables multiple users to interact with the surface computing equipment 104 and with user data without interference from other, unauthenticated users. After authentication by the authentication component 202, touch input can be analyzed to determine if the input originates from an authenticated user. The surface computing equipment 104 includes a touch input component 204 that associates touch input with user 110 and enables the touch input to be processed accordingly.

According to an aspect, the authentication object 106 can convey authentication information 108 via a modulated capacitance transmitted through a user's body. When user 110 provides touch input to the surface computing environment 104, authentication information 108 is conveyed as well. The touch input component 204 can extract the authentication information 108 from the touch input to determine if the touch is authenticated. For instance, the touch input component 204 can employ a filter (e.g., low pass filter, high pass filter, etc.) to extract the authentication information 108. Accordingly, interactions related to data of user 110 or otherwise related to user 110 are not accepted by the surface computing equipment 104 unless the touch input component 204 extracts authentication information 108 associated with user 110. In another aspect, the authentication object can provide a modulate capacitance directly to the surface computing equipment 104. For instance, user 110 can utilize the authentication object 106 to provide touch input (e.g., tap the authentication object 106 on a surface).

Pursuant to another example, the touch input component 204 can determine authenticated input based on a location of touch input on a surface relative to a location of the authentication object 106. Location of touch input is determined via a capacitance array or other similar mechanism included in the surface computing equipment 104. Location of the authentication object 106 can be detected through optical (e.g., visual) or physical observation. For example, the authentication object 106 can be placed upon a surface of the surface computing equipment 104. A shadow or shape of the authentication object 106 can be detected and/or the authentication object 106 can vibrate to inform the surface computing equipment 104 of the object's location. In addition, near-field communications, Bluetooth or other wireless communication protocols can be employed to infer a location of the authentication object 106.

In accordance with an aspect, location of the authentication object 106, once determined, can be utilized to create an authenticated halo and/or region of the surface. For example, the authentication object 106 can be placed upon the surface and a region or area in the vicinity of the object 106 can be displayed. The touch input component 204 can associate touch input obtained within the region with the authentication information 108 and, correspondingly, the user 110.

It is to be appreciated that the system 200 can include any suitable and/or necessary interface component (not shown), which provides various adapters, connectors, channels, communication paths, etc. to integrate the authentication component 202 and touch input component 204 into virtually any application, operating and/or database system(s) and/or with one another. In addition, the interface component can provide various adapters, connectors, channels, communication paths, etc., that provide for interaction with and between the authentication component 202, the touch input component 204, and any other device and/or component associated with the system 200.

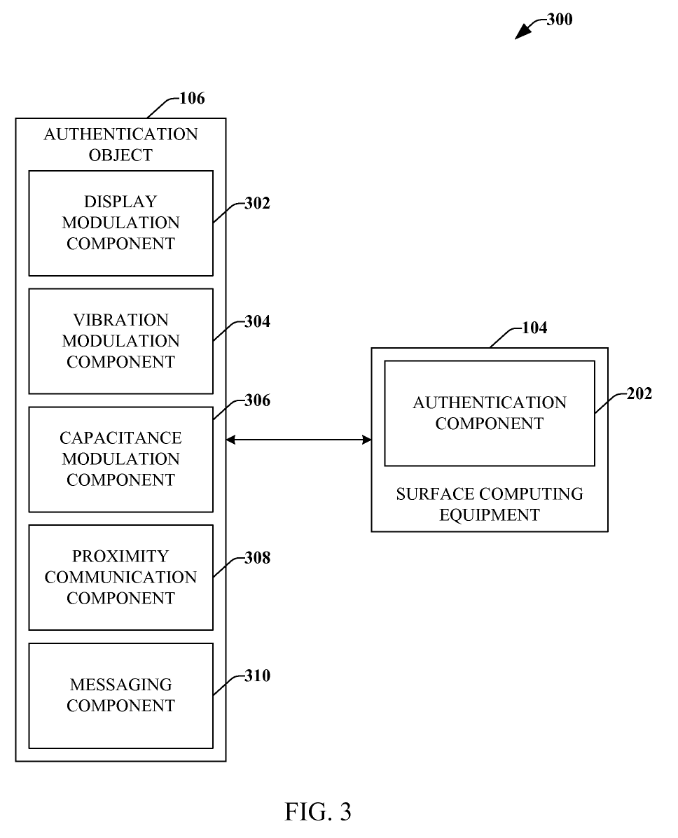

FIG. 3 illustrates a system 300 that facilitates conveyance of authentication input to a surface computing environment in accordance with one or more aspects. Similar to the above systems, system 300 can be utilized in a surface computing environment 102 that includes surface computing equipment 104 and at least one authentication object 106. The authentication object 106 can provide authentication information to the surface computing equipment 104 that is analyzed, verified and associated with a user as described above.

In accordance with some aspects, the authentication object 106 can employ a variety of mechanisms to transmit or convey authentication information to the surface computing equipment 104. For example, the authentication object 106 can modulate a display pattern (e.g., lighting), a vibration pattern, or a capacitance to convey authentication information. In addition, the authentication object 106 can employ near-field communication, Bluetooth, text messaging or other suitable wireless communication technology.

The authentication object 106 can include a display modulation component 302 that modulates a display to encode authentication information. For instance, the authentication object 106 can include a display (e.g., mobile device display with backlight) or other light emitting portion that can be configured to emit a pattern or light sequence that can encode authentication information. The surface computing equipment 104 can include cameras or light sensors (not shown) that obtain the modulated light sequence. The authentication component 202 can analyze the sequence and demodulate the information to facilitate authentication of the object 106 and corresponding user (not shown).

The authentication object 106 can include a vibration modulation component 304 that can control a vibrator (not shown) to transmit authentication information. The vibration modulation component 304 can convey authentication information through encoding the information with a rhythmic, character, numerical, binary or other encoding format. For example, the authentication object 106 can be placed in physical contact with the surface computing environment 104. The vibration modulation component 304 can activate a vibrator included in object 106 to provide authentication information to the authentication component 202 for verification.

In addition, the authentication object 106 includes a capacitance modulation component 306 that modulates information as a radio frequency signal that can be transmitted through a user's body. For example, the RF signal can alter a capacitance of user's touch on the surface computing equipment 104. The surface computing equipment 104 can receive capacitive input and process it accordingly to extract the RF signal encoded with authentication information. In accordance with another aspect, the authentication object 106 can transmit a capacitive signal generated by the capacitance modulation component 306 directly to the surface computing equipment 104. For instance, the authentication object 104 can be tapped on the surface to transmit the signal.

In accordance with another aspect, the authentication object 106 can transfer authentication information via a proximity communication protocol such as, but not limited to, Bluetooth, near field communications, or other similar protocol. The authentication object 106 includes a proximity communication component 308 that can establish a proximity communication channel with the surface computing equipment 104. Pursuant to an illustration, the authentication object 106 can pair with the surface computing equipment 104 upon moving into an appropriate range for communication. Upon successfully pairing, the authentication object 106 can transmit authentication information via the proximity communication channel for verification by the authentication component 202. In addition, the proximity communication channel can be employed to transfer other data beyond authentication information. For instance, user data retained by the authentication object 106 can be transmitted via the proximity communication channel after successful authentication.

According to another aspect, the authentication object 106 and surface computing equipment 104 can employ text messaging (e.g., SMS) to transfer authentication information. To facilitate such exchange, the authentication object 106 can include a messaging component 3 10. The authentication object 106 can utilize the messaging component 310 to send authentication information via a wireless communications network (e.g., cellular telephone network). For instance, a telephone number associated with the surface computing equipment 104 can be displayed within the surface computing environment 102. A user, employing the authentication object 106, can send a message to the displayed telephone number. The message can include authentication information analyzed and verified by the authentication component 202. According to one aspect, the message can include a request for a return message. The authentication object 106 can be placed on the surface computing equipment 104 such that a display or other feature that presents messages is visible to the surface computing equipment 104. The surface computing equipment 104 can employ sensors and/or cameras to observe a return message sent to the authentication device 106 and, accordingly, complete verification. In accordance with this example, a telephone number can represent a unique user identifier. In addition to verifying identity, visualizing the authentication object 106 can facilitate locating the object 106 to enable authentication of touch input as described above.

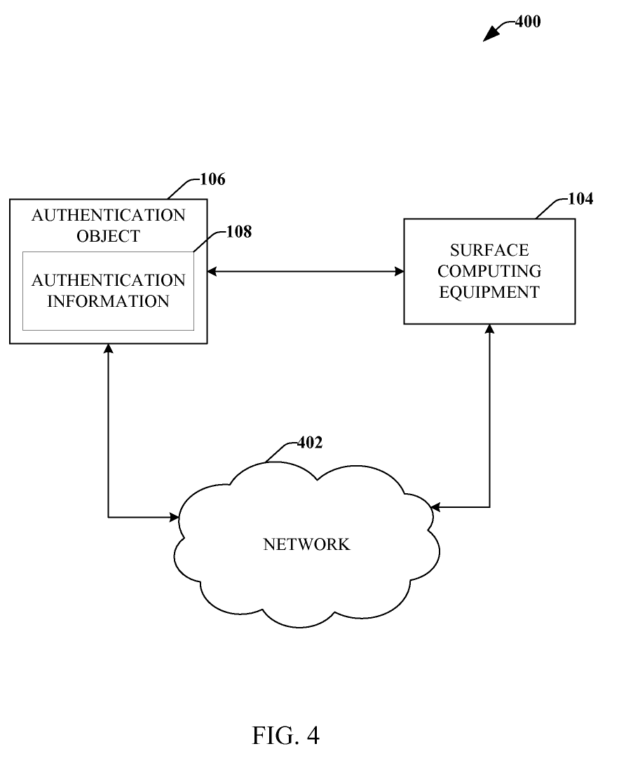

FIG. 4 illustrates a system 400 that facilitates authenticating a user with a surface computing environment according to an aspect of the subject disclosure. System 400 includes surface computing equipment 104 that can be in a surface computing environment as described above with reference to FIGS. 1-3. System 400 can also include authentication object 106 that retains authentication information 108 as discussed supra.

In accordance with an aspect, the authentication object 106 and the surface computing equipment 104 can communicate via a network 402. For example, the network 402 can be the Internet, a local area network, a wide area network, a wireless local area network, or other suitable network. Pursuant to an illustration, the authentication object 106 can be an Internet Protocol (IP) capable device such as, but not limited to a mobile device (e.g., cell phone, smart phone, etc.) or other electronic or computing device (e.g., PDA, laptop . . . ). The authentication object 106 can employ a network communication protocol such as TCP/IP to establish a communication channel with the surface computing equipment 104 over network 402. It is to be appreciated that other suitable communication and/or transport protocols can be employed for data exchange over network 402.

According to an example, the authentication object 106 and surface computing equipment 104 can establish a TCP/IP channel or other suitable network channel. The channel can be created when the authentication object 106 enters the surface computing environment. In addition, the channel can also be created by an explicit request of a user or by the surface computing equipment 104 when a user interacts therewith.

The authentication object 106 can utilize the channel to convey authentication information 108 to the surface computing equipment 104. The surface computing environment 104 can analyze the authentication information 108 to verify an identity of a user and/or the authentication object 106. In addition to identity verification, the authentication information 108 can be utilized to secure a communication channel. For instance, the authentication information 108 can include cryptographic keys that establish encryption of data between the authentication component 106, surface computing equipment 104 and/or any network entities included in network 402.

In accordance with another aspect, the secure channel can be employed for data transfers between the authentication object 106 and the surface computing environment 104. For instance, user data can be transferred therebetween. The user data can include photos, videos, music and/or any other use media, files or information. With verification of a user's identity via authentication information 108, the user data can be accessed, manipulated and interacted with on the surface computing equipment 104

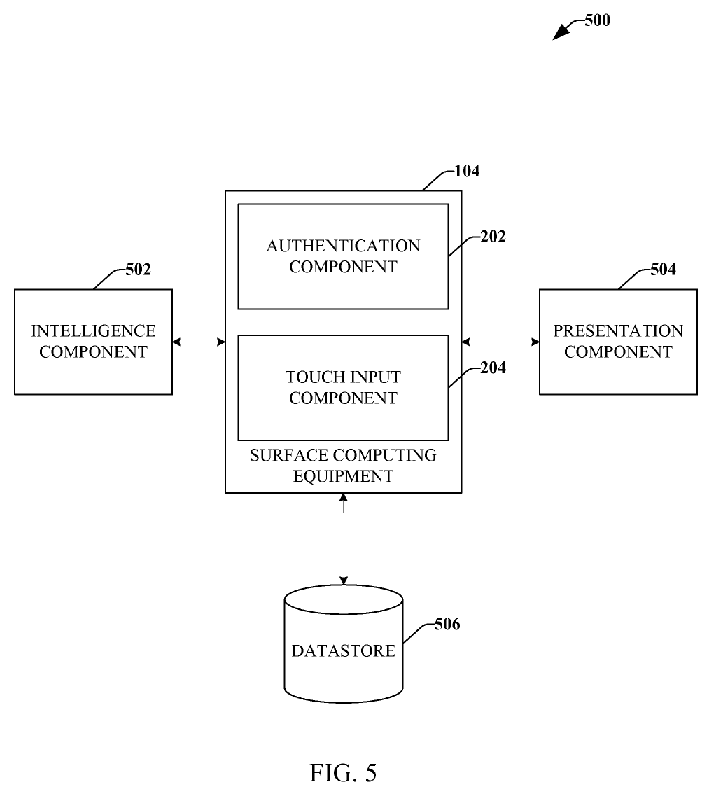

FIG. 5 illustrates a system 500 that employs intelligence to facilitate utilizing dynamic subroutines generated from static subroutines. The system 500 can include surface computing equipment 104 that includes the authentication component 202 and touch input component 204 which can be substantially similar to respective equipment, authentication components and touch input components described in previous figures. The system 500 further includes an intelligence component 502. The intelligence component 502 can be utilized by the surface computing environment 402 to facilitate verifying authentication information and/or authenticating touch input from users. For example, the intelligence component 502 can infer a user associated with a touch point based at least in part on authentication information, location of touch point and location of an authentication object. In addition, the intelligence component 502 can infer when a touch point originates from an unauthorized user through observation of a user generating the touch point. For example, a touch point can be observed to originate from a user on an opposite side of a table or surface of surface computing equipment 104 from a user associated with the authentication object. Moreover, the intelligence component 502 can infer authentication information from one or more historical interactions or observations. For example, a user can temporarily interact with equipment 104 and momentarily leave the environment. After returning, the intelligence component 504 can facilitate a quick re-authentication of a user.

Moreover, it is to be understood that the intelligence component 502 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, . . . xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naive Bayes, Bayesian networks, decision trees, neural networks, fuzzy logic models, and probabilistic classification models providing different patterns of independence can be employed. Classification as used herein also is inclusive of statistical regression that is utilized to develop models of priority.

The surface computing equipment 104 can further utilize a presentation component 504 that provides various types of user interfaces to facilitate interaction between a user and any component coupled to the surface computing equipment 104. As depicted, the presentation component 504 is a separate entity that can be utilized with the surface computing equipment 104. However, it is to be appreciated that the presentation component 504 and/or similar view components can be incorporated into the surface computing equipment 104 and/or a stand-alone unit. The presentation component 504 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into surface computing equipment 104.

The user can also interact with the regions to select and provide information via various devices such as a mouse, a roller ball, a touchpad, a keypad, a keyboard, a touch screen, a pen and/or voice activation, a body motion detection, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via text rendered on a display and/or an audio tone) the user for information via providing a text message. The user can then provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, EGA, VGA, SVGA, etc.) with limited graphic support, and/or low bandwidth communication channels.

The surface computing environment 104 can further employ a data store 506. The data store 506 can be utilized to retain user profiles employed to verify authentication information, user data, application data, operating system data and the like. It is to be appreciated that the data store 506 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM. The data store 506 of the subject systems and methods is intended to comprise, without being limited to, these and any other suitable types of memory. In addition, it is to be appreciated that the data store 506 can be a server, a database, a hard drive, a pen drive, an external hard drive, a portable hard drive, and the like.

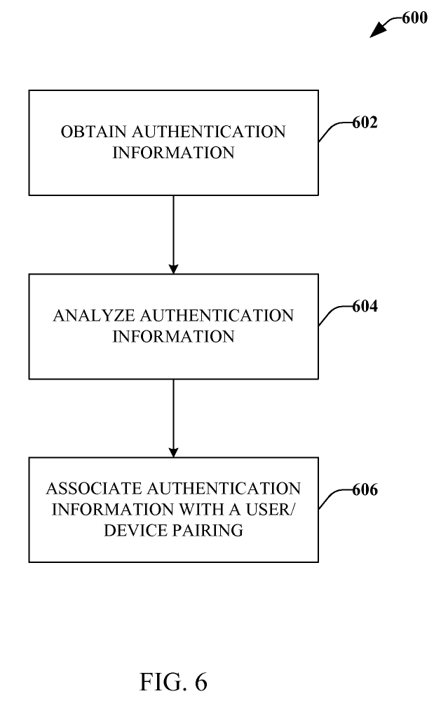

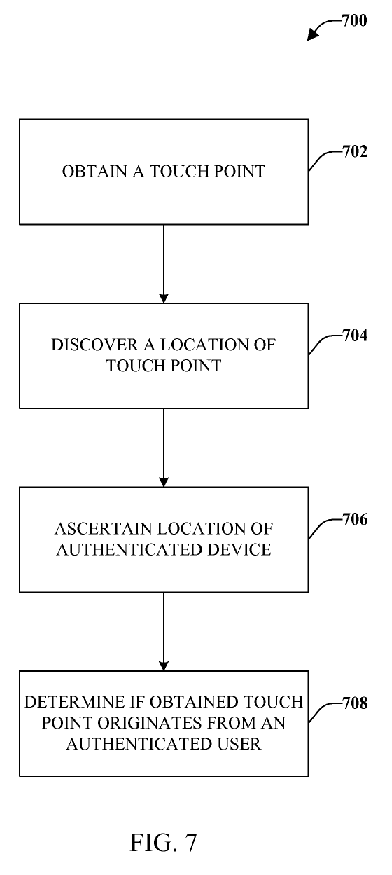

FIGS. 6-7 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts. For example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 6 illustrates a method 600 that facilitates obtaining authentication information from an authentication object in a surface computing environment. At reference numeral 602, authentication information is obtained. Pursuant to an illustration, the authentication information can include passwords, user IDs, pass codes, PINs, cryptographic keys (e.g., shared keys, public key/private key pairs, etc.), biometric information and the like. In addition, the authentication information can be obtained from an authentication object. In one aspect, the authentication object can be carried by a user interacting within the surface computing environment. The authentication object can include, without limitation, a mobile device (e.g., cell phone, smart phone, PDA, and so on), a computing device (e.g., laptop, pocket computer, tablet, etc.) or other suitable electronic device. It is to be appreciated that the authentication object can be wearable such as a watch, bracelet, ring, necklace, pendant or other jewelry item.

According to an aspect, the authentication object can be obtained automatically, manually, and/or by request. For instance, the authentication information can be obtained when the authentication object enters the surface computing environment and/or traverses within a predetermined range from surface computing equipment (e.g., table, wall, desk, etc.) that acts as a display for user interactions. In addition, the authentication information can be conveyed automatically to the surface when a user interacts (e.g., touches) with the surface while carrying the authentication object retaining the authentication information. Pursuant to another illustration, the authentication information can be conveyed manually by a user. For example, a user can place the authentication object on a surface and initiate transfer according to one or mechanisms (e.g., light modulation, vibration modulation, capacitance modulation, text messaging, near field communications, and the like) described previously. In addition, authentication information can be conveyed in response to a request. For example, the surface can request authentication information upon receiving user input for a first time.

At reference numeral 604, the obtained authentication information is analyzed. For instance, the surface can verify the authentication information against a user profile, user account, network service and the like. In addition, the authentication information can include login information to enable a user to login to the surface.

At reference numeral 606, the authentication information is associated with a user/device pairing. For instance, the authentication information can identify a user and a user's authentication object. The association can facilitate verification of authorized input from the user based at least in part on the authentication object, data from the authentication object and/or a location of the authentication object.

FIG. 7 illustrates a method 700 that facilitates employing authentication objects to enable authenticated input in a surface computing environment. At reference numeral 702, a touch point is obtained. The touch point can be created when a user touches a surface in the surface computing environment. For example, the user can touch a surface with a finger, a hand, or an input device such as a stylus or other object. In addition, a touch point can be generated when the taps an authentication object on the surface.

At reference numeral 704, a location of the touch point is determined. According to an aspect, touch points can be created by inductance and/or capacitance. The surface can include an inductance or capacitance array that can provide a location of a touch point on the surface. At reference numeral 706, a location of an authenticated device is ascertained. For example, a device such as a mobile device, electronic device, jewelry item and so forth can be an authentication object that includes authentication information conveyed to the surface as described supra. Pursuant to an illustration, the location of the device can be determined via optical and/or physical observations. For instance, the device can be placed on the surface. In addition, a location can be determined via near field communications between the surface and the device.

At reference numeral 708, it is determined if the obtained touch point originates from an authenticated user or is otherwise authenticated. For example, the touch point can include an embedded RF signal that includes encoded authentication information. The RF signal can modulate a capacitance received by a surface when a touch point is generated. The surface can extract the authentication information to determine if the input is valid. According to another aspect, the determined location of the authenticated device can be employed to create an authenticated region or area on the surface. A touch point within the region is determined to be authenticated in accordance with the authentication information included on the authenticated device.

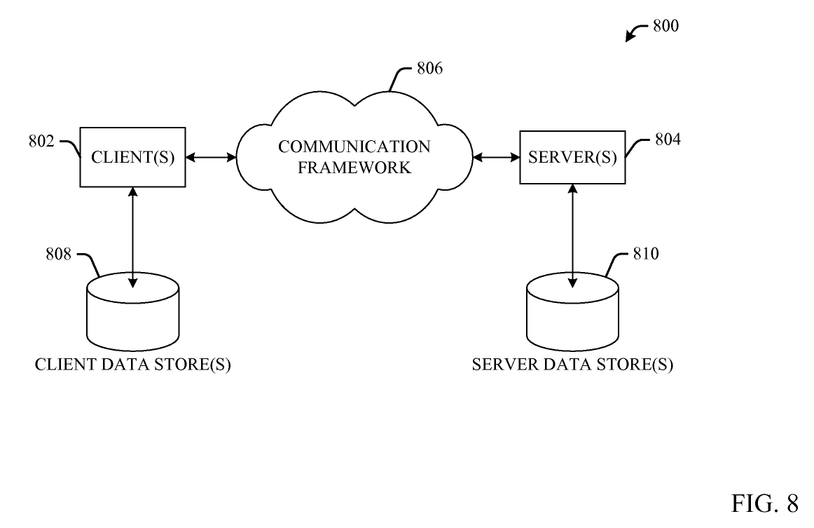

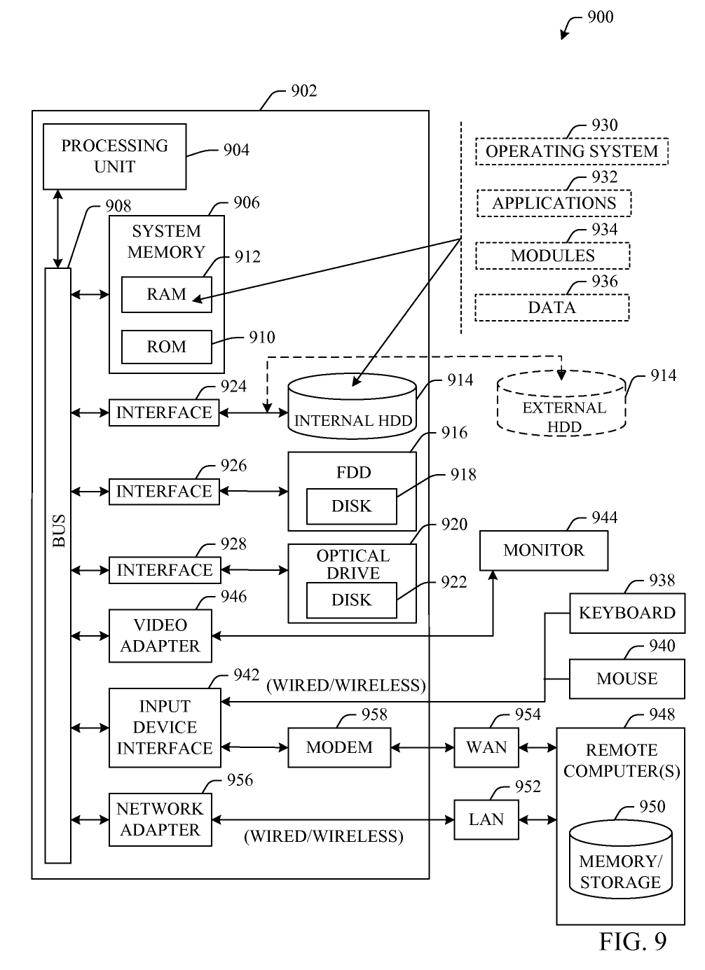

In order to provide additional context for implementing various aspects of the claimed subject matter, FIGS. 8-9 and the following discussion is intended to provide a brief, general description of a suitable computing environment in which the various aspects of the subject innovation may be implemented. For example, a reflection component that generates full descriptions of static subroutines and a dynamic method component that creates dynamic subroutines at runtime based upon the descriptions, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 8 is a schematic block diagram of a sample-computing environment 800 with which the claimed subject matter can interact. The system 800 includes one or more client(s) 810. The client(s) 810 can be hardware and/or software (e.g., threads, processes, computing devices). The system 800 also includes one or more server(s) 820. The server(s) 820 can be hardware and/or software (e.g., threads, processes, computing devices). The servers 820 can house threads to perform transformations by employing the subject innovation, for example.

One possible communication between a client 810 and a server 820 can be in the form of a data packet adapted to be transmitted between two or more computer processes. The system 800 includes a communication framework 840 that can be employed to facilitate communications between the client(s) 810 and the server(s) 820. The client(s) 810 are operably connected to one or more client data store(s) 850 that can be employed to store information local to the client(s) 810. Similarly, the server(s) 820 are operably connected to one or more server data store(s) 830 that can be employed to store information local to the servers 820.

With reference to FIG. 9, an exemplary environment 900 for implementing various aspects of the claimed subject matter includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable programmable ROM (EEPROM), or flash memory. Volatile memory 920 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 912 also includes removable/non-removable, volatile/non-volatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in the suitable operating environment 900. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers, among other output devices 940, which require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the advertising techniques of the invention. The claimed subject matter contemplates the use from the standpoint of an API (or other software object), as well as from a software or hardware object that operates according to the advertising techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates authentication of a user in a surface computing environment, comprising:
an authentication component that obtains authentication information from at least one device uniquely associated with a user, the authentication component determines an identity of the user based at least in part on the authentication information; and
a touch input component that associates a touch input with the user to ascertain if the touch input is authenticated.

2. The system of claim 1, the touch input component associates the touch input with the user based at least in part on a location of the device and a location of the touch input on a surface in the surface computing environment.

3. The system of claim 2, the touch input component determines the location of the device based upon a visual observation of the device placed on the surface.

4. The system of claim 3, the touch input component generates an authenticated region on the surface around the device placed on the surface.

5. The system of claim 4, the touch input component associates touch input within the region with the user uniquely associated with the device placed on the surface.

6. The system of claim 1, the touch input component obtains touch input that includes a signal modulated with the authentication information from the at least one device.

7. The system of claim 6, the touch input component extracts the authentication information from the touch input and matches the extracted information to information obtained by the authentication component.

8. The system of claim 7, the touch input component associates touch input with the user associated with the at least one device upon successful matching of information.

9. The system of claim 6, the authentication component obtains authentication information from the at least one device via a capacitively coupled electrical signal modulated with the information.

10. The system of claim 6, the authentication component obtains authentication information from the at least one device via a visible signal modulated with the information.

11. The system of claim 1, the authentication component obtains authentication information from the at least one device via a vibration pattern modulated with the information.

12. The system of claim 1, the authentication component obtains authentication information from the at least one device via textual input.

13. The system of claim 1, the authentication component obtains authentication information from the at least one device via a near field communication channel.

14. The system of claim 1, the authentication component employs the obtained authentication information to create a secure communication channel between a surface in the surface computing environment and the at least one device.

15. The system of claim 1, wherein a color is assigned to the user such that visual feedback in the assigned color informs the user that touch points are authenticated.

16. The system of claim 1, the at least one device is a mobile device.

17. A method that facilitates authenticated interactions with surface computing equipment in a surface computing environment, comprising:
obtaining authentication information from at least one authentication object uniquely coupled to a user;
analyzing the authentication information to ascertain and verify an identity of at least one of the user or the authentication object; and
employing at least one of the authentication information or location of the authentication object relative to a surface of the surface computing equipment to authenticate touch input received by the surface.

18. The method of claim 17, further comprising establishing a secure communication channel between the authentication object and the surface computing equipment.

19. The method of claim 17, further comprising generating an authenticated region around the authentication object placed on the surface of the surface computing equipment.

20. A system that enables authentication of a user in a surface computing environment via a device, comprising:
means for receiving authentication information from at least one device carried by a user;
means for verifying an identity of the user based at least in part on the received authentication information;
means for transferring user data to a surface in the surface computing environment; and
means for associating touch point with at least one of the device or the user.
